(19) United States
(12) Patent Application Publication
(10) Pub. No.: US 2026/0079447 A1
(43) Pub. Date: Mar. 19, 2026

(54) DYNAMIC DISPLAY DEVICE DESIGNED TO BE INTEGRATED INTO A TIMEPIECE

(71) Applicant: The Swatch Group Research and Development Ltd, Marin-Epagnier (CH)

(72) Inventors: Nicolas FRANÇOIS, Neuchâtel (CH); Pierpasquale TORTORA, Neuchâtel (CH); Ardiana SAMAKE SHKODRA, Neuchâtel (CH)

(73) Assignee: The Swatch Group Research and Development Ltd, Marin-Epagnier (CH)

(21) Appl. No.: 19/269,398

(22) Filed: Jul. 15, 2025

(30) Foreign Application Priority Data
Sep. 17, 2024 (EP) 24200853.0

(51) Int. Cl. G04B 19/247; G04B 19/04

(52) U.S. Cl. CPC G04B 19/247; G04B 19/042

(57) ABSTRACT

A display device (1) designed to be integrated into a timepiece, such as a watch, the display device (1) including a first lenticular grating (11) and a first supporting element including a pattern arranged so that it can be seen through the first lenticular grating, the device being remarkable in that it includes a second supporting element including a second lenticular grating (12), the second supporting element extending above the first supporting element and being arranged so that the pattern can be seen through both the first and second lenticular gratings (12), one of the first or second supporting element being a supporting element rotating around an axis perpendicular to the plane P in which the pattern extends.

### CROSS REFERENCE TO RELATED APPLICATIONS

This application claims priority to European Patent Application No. 24200853.0 filed September 17, 2024, the entire contents of which are incorporated herein by reference.

### TECHNICAL FIELD OF THE INVENTION

The invention relates to a display device designed to be integrated into a timepiece and featuring a dynamic display.

The invention relates more specifically to a display device designed to be integrated into a timepiece, comprising a lenticular grating and a first supporting element comprising a pattern arranged so that it can be seen through the first lenticular grating.

The display device is designed in particular, but not exclusively, to be integrated into a wearable object such as a watch.

### TECHNOLOGICAL BACKGROUND

There are known display devices that use a lenticular grating to provide a dynamic display.

In the prior art, “lenticular grating” refers to a grid formed by a layer of juxtaposed cylindrical lenses extending parallel to each other. In most cases, these “cylindrical” lenses are not actually cylindrical in shape, meaning that the expression “cylindrical lens” is to be broadly interpreted as referring to any lens comprising an optical axis and having, in cross-section, a profile that is invariant over its entire length. Lenticular gratings usually come in the form of relatively large sheets that can be cut to the desired size. These lenticular sheets are made from a transparent, stable material. They normally have a smooth backing that enables the sheet to be attached to a substrate.

One known use of lenticular gratings consists in arranging a reproduction of two patterns with an identical design but different sizes under a lenticular grating. Depending on the angle from which the patterns are viewed, the viewer will perceive first one of the patterns, then the other pattern that is different from the first, resulting in a zoom effect that creates a dynamic display. The reproduction of the two patterns is carried on a substrate and is covered by the lenticular grating. Patent application EP3032357 describes the use of a lenticular grating in a display device designed to be integrated into a wearable object.

Another known use of lenticular gratings consists in arranging, under a lenticular grating, a pattern fragmented into straight strips sandwiched between transparent strips, the straight strips of the pattern and the transparent straight strips being arranged in succession with the same step as the step between the cylindrical lenses of the lenticular grating that cover the pattern. Thus, depending on the angle at which the viewer looks at the lenticular grating, the viewer sees either the pattern at an enlarged scale or what is behind the lenticular grating, the latter being transparent. One such use of a lenticular grating is described in patent application EP3128359.

The drawback of these display devices is that the dynamic display only appears after a viewer action such as a wrist rotation or head movement, in the example of a watch fitted with one of these display devices.

The invention aims to provide a dynamic (animated) display device designed to be integrated into a wearable object without any specific action on the part of the viewer. “Specific viewer action” means any movement by the viewer (wrist and head movements).

### SUMMARY OF THE INVENTION

According to a first aspect, the invention relates to a display device designed to be integrated into a timepiece, such as a watch, said display device comprising a first lenticular grating and a first supporting element comprising a pattern arranged so that it can be seen through the first lenticular grating, the pattern being fragmented into straight strips extending parallel to each other in a plane P parallel to the first supporting element, the first lenticular grating being formed of a plurality of juxtaposed cylindrical or spherical lenses extending parallel to each other and having a focal length such that the focal plane of the lenses is coincident with the plane P, the lenses of the lenticular grating having a step corresponding to the step at which the strips in the first group, like the strips in the second group, are arranged in succession. Preferentially, the straight strips are formed of at least a first group of strips defining first images and a second group of strips defining second images, the first and second images forming the pattern, the straight strips in the first group of strips being alternately arranged with the strips in the second group of strips so that there is always a strip in the first group of strips adjacent to a strip in the second group of strips. The device is remarkable in that it comprises a second supporting element comprising a second lenticular grating, the second supporting element extending above the first supporting element and being arranged so that the pattern can be seen through both the first and second lenticular gratings, one of the first or second supporting elements being a supporting element rotating around an axis perpendicular to the plane P.

By arranging two lenticular gratings, one of which is associated with a mobile supporting element, the pattern creates an animated effect with no need for any specific action by the viewer, such as a wrist or head movement.

Advantageously, the lenses of one of the first or second lenticular gratings have a step between each lens that is similar or comparable to the step between the lenses of the other first or second lenticular grating.

Advantageously, the rotating supporting element is a date disc.

Advantageously the rotating supporting element is an oscillating mass.

Advantageously, the rotating supporting element is an indicator organ.

Advantageously, the indicator organ is a transparent second hand located above the first lenticular grating.

Advantageously, the other of the first or second supporting elements is a fixed supporting element.

Advantageously, the fixed supporting element is a dial.

Advantageously, the first lenticular grating is the first supporting element and/or the second lenticular grating is the second supporting element.

Advantageously, a second pattern is sandwiched between the second lenticular grating and the second supporting element.

According to another aspect, the invention relates to a watch comprising a display device according to any of the preceding claims.

### BRIEF DESCRIPTION OF THE FIGURES

Other features and advantages of the invention will be apparent from the following detailed description of the invention, provided by way of example and made with reference to the attached figures, in which:

FIG. 1 shows a partial schematic cross-sectional view of a date watch comprising a display device according to a first exemplary embodiment of the invention;

FIG. 2A shows a design plan illustrating a top view of an exemplary pattern;

FIG. 2B shows a cross-sectional view of an exemplary lenticular grating corresponding to the pattern illustrated in FIG. 2A;

FIG. 3 shows a partial schematic cross-sectional view of a watch comprising a display device according to another exemplary embodiment of the invention.

### DETAILED DESCRIPTION OF THE INVENTION

In the examples that will be described, the display device according to the invention comprises a first supporting element carrying a pattern, a second supporting element arranged above the first supporting element, and a first and a second lenticular grating. One of the first or second supporting elements is a rotating supporting element while the other of the first and second supporting elements is a fixed supporting element.

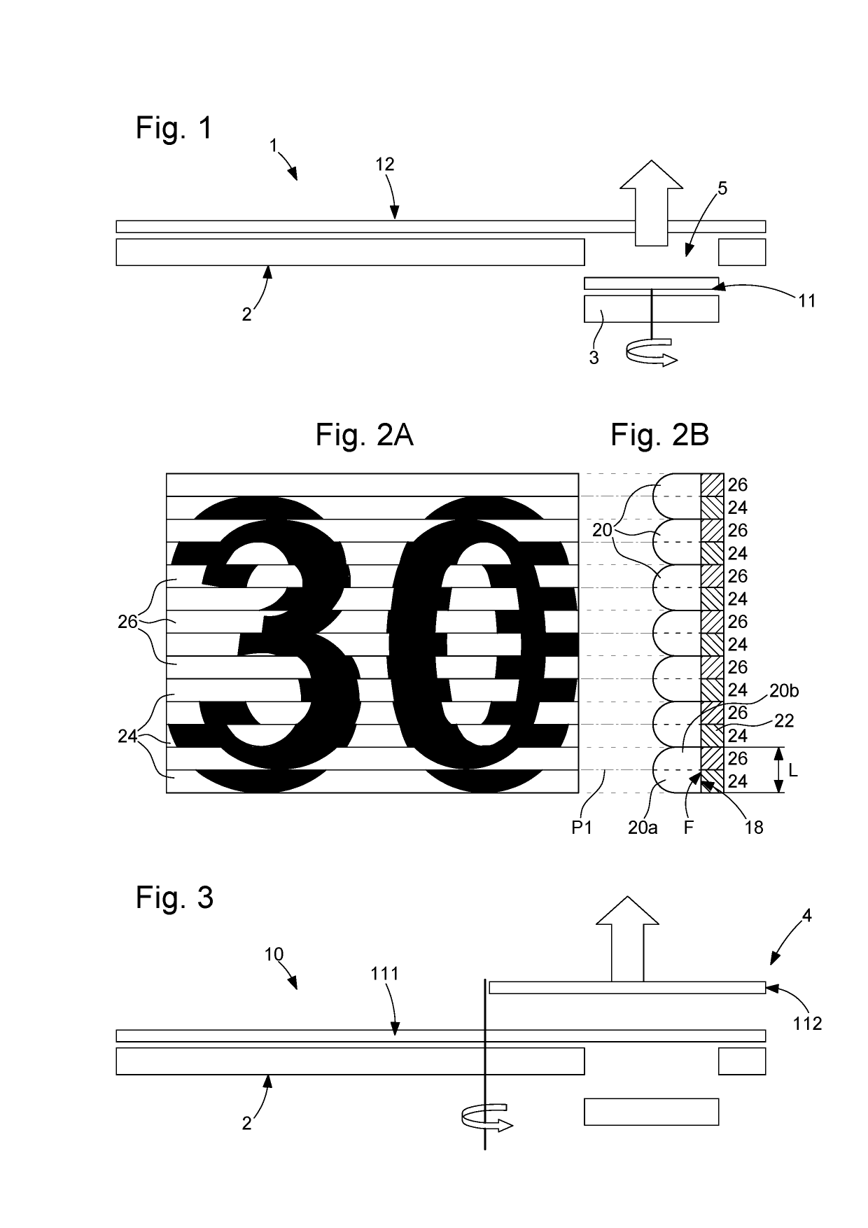

FIG. 1 shows a partial schematic cross-sectional drawing of a date watch comprising a display device according to a first exemplary embodiment of the invention.

In this example, the display device 1 comprises a dial 2 and a rotating disc positioned behind the dial 2. The rotating disc is a date disc 3 that carries the days of the month, for example. It is driven by a horology mechanism (not shown). The date disc 3 is visible through an opening 5 in the dial 2. The opening 5 in the dial 2 faces the date disc 3. It advantageously has dimensions that are preferably substantially identical to those of the date disc 3.

In the example described the date disc 3 is the rotating supporting element (defining the first supporting element) while the dial 2 is the fixed supporting element (defining the second supporting element).

The first lenticular grating 11 is positioned on the date disc 3, while the second lenticular grating 12 is carried by the dial 2.

The pattern is located between the first lenticular grating 11 and the date disc 3. The pattern is divided into straight strips 24, 26 extending parallel to each other in a plane P parallel to the date disc 3. The straight strips are formed of at least a first group of strips defining first images and a second group of strips defining second images. The straight strips in the first group are alternately arranged with the strips in the second group so that there is always a strip in the first group of strips adjacent to a strip in the second group of strips.

An example of a pattern display is shown in FIGS. 2A and 2B. According to a particular exemplary display, the first images define a number (“30”) with a first size and the second images, which have the same signification as the first images, have a second size different from that of the first images. Of course, this is an exemplary display, as other patterns can be used without departing from the scope of the invention, depending on the pattern and the intended animation of the pattern. Moreover, in the example illustrated, the pattern is fragmented into two groups of strips. Of course, the invention is not limited to such an embodiment, as the pattern can comprise more than two interwoven groups of strips depending on the desired animation.

The second lenticular grating 12 is arranged on the dial 2 so as to cover its opening 5. The pattern is thus seen through both the first 11 and the second 12 lenticular gratings. In the example shown, the second lenticular grating 12 covers the entire surface of the dial 2, including the opening 5 in the dial 2. According to a variant embodiment not shown, the lenticular grating can be designed to essentially cover the opening 5 of the dial 2.

The first and second lenticular gratings 11, 12 are respectively formed of a plurality of juxtaposed cylindrical or spherical lenses extending parallel to each other. “Cylindrical” lenses are not actually cylindrical in shape and the term “cylindrical” is to be broadly interpreted in this description, whereby the expression “cylindrical lens” refers to any lens comprising an optical axis O-O and having, in cross-section, a profile that is invariant over its entire length. These gratings are usually in the form of sheets made of a transparent, stable material. Conventionally, the lenses have a smooth backing 22 that enables the sheet to be attached to a substrate.

According to an advantageous variant, the lenticular grating can be the plane that carries the pattern to be displayed. In this variant, the pattern is applied directly to the smooth backing 22 of the lenticular sheet, for example by printing, with the lenticular grating carrying the pattern covering the date disc 3. According to another variant, the pattern is printed directly on the date disc 3 and is covered by the first lenticular grating 11. According to another variant, the pattern is applied to a thin plastic sheet placed between a substrate and the lenticular grating, the whole forming the date disc 3.

The lenses 20 in the first lenticular grating 11 have a focal length such that the focal plane of the lenses 20 in said first group coincides with the plane P. Moreover, and advantageously, the first and second lenticular gratings 11, 12 have a step between each lens that is comparable, substantially similar or strictly similar.

The first group of straight strips 24 and the second group of straight strips 26 are arranged in succession with the same step with which the lenses 20 in the first lenticular grating 11 cover the pattern.

FIG. 3 shows a partial schematic drawing of a display device 10 for a watch according to another embodiment of the invention.

In this example, the display device 10 comprises an indicator organ formed by at least one of the hands of the watch, preferably the second hand 4, which forms the rotating element of the display device 10. As before, the fixed element is the dial 2. In this example, the rotating element forms the second supporting element, while the fixed element forms the first supporting element.

As shown in FIG. 3, the first lenticular grating 111 is carried by the dial 2, the pattern being sandwiched between the first lenticular grating 111 and the dial 2. As previously described, the pattern can either be affixed to the smooth backing 22 of the first lenticular grating 111, or affixed directly to the dial 2, or affixed to a thin sheet, for example of plastic, placed between a substrate and the lenticular grating, the assembly forming the dial 2. “Affixed” is taken to mean the printing of the pattern or any other known technique enabling the pattern to be reproduced on the particular medium.

The second lenticular grating 112 forms the second hand 4. This is, of course, an exemplary embodiment, as other arrangements can be foreseen without departing from the scope of the invention. In particular, it can be foreseen that the second lenticular grating 112 is arranged on a supporting element constituting the hand which, in this case, will advantageously be transparent to allow the pattern to be seen through the second and first lenticular gratings 112, 111.

The first and second lenticular gratings 111, 112 respectively have the same features as the first and second lenticular gratings 11, 12 in the previously described example.

In the previously described example, the display device comprises a single pattern associated with the lowermost supporting element and the associated lenticular grating. However, a configuration can also be foreseen in which the display device comprises a second pattern associated with the upper supporting element.

It should be noted that in other examples of this display device, the rotating supporting element (defining the first supporting element) can be an oscillating mass.

The above description of the invention is provided by way of example. It is understood that the person skilled in the art is capable of arriving at different variants of the invention without departing from the scope of the invention.

### Terminology

1, 10 display device

2 dial

3 date disc

4 second hand

5 opening

11, 111 first lenticular grating

12, 112 second lenticular grating

20 lens

24 straight strips in the first group of strips

26 straight strips in the second group of strips

22 backing

1. A display device (1, 10) to be integrated into a timepiece, such as a watch, said display device (1, 10) comprising a first lenticular grating (11, 111) and a first supporting element comprising a pattern arranged so that it can be seen through the first lenticular grating, the pattern being fragmented into straight strips (24, 26) extending parallel to each other in a plane P parallel to the first supporting element, the straight strips (24, 26) being formed of at least a first group of strips defining first images and a second group of strips defining second images, the first and second images forming the pattern, the straight strips (24) in the first group being alternately arranged with the straight strips (26) in the second group such that there is always a straight strip (24) in the first group adjacent to a strip (26) in the second group, the first lenticular grating (11, 111) being formed of a plurality of juxtaposed cylindrical or spherical lenses (20) extending parallel to each other and having a focal length such that the focal plane of the lenses is coincident with the plane P, the lenses (20) in the lenticular grating (11, 111) having a step corresponding to the step at which the strips (24) in the first group, like the straight strips (26) in the second group, are arranged in succession,
wherein the display device (1, 10) comprises a second supporting element comprising a second lenticular grating (12, 112), the second supporting element extending above the first supporting element and being arranged so that the pattern can be seen through both the first and second lenticular gratings (12, 112), one of the first or second supporting element being a supporting element rotating around an axis perpendicular to the plane P.

2. The display device (1, 10) according to claim 1, wherein the lenses of one of the first or second lenticular gratings (11, 12, 111, 112) have a step between each lens similar to the step between the lenses of the other first or second lenticular grating (11, 12, 111, 112).

3. The display device (1, 10) according to claim 1, wherein the rotating supporting element is a date disc (3).

4. The display device (1, 10) according to claim 1, wherein the rotating supporting element is an oscillating mass.

5. The display device (1, 10) according to claim 1, wherein the rotating supporting element is an indicator organ.

6. The display device (1, 10) according to claim 1, wherein the rotating supporting element is an oscillating mass and the indicator organ is a transparent second hand (4) positioned above the first lenticular grating (111).

7. The display device (1, 10) according to claim 1, wherein the other of the first or second supporting elements is a fixed supporting element.

8. The display device (1, 10) according to claim 1, wherein the rotating supporting element is an oscillating mass and the indicator organ is a transparent second hand (4) positioned above the first lenticular grating (111) and the fixed supporting element is a dial (2).

9. The display device (1, 10) according to claim 1, wherein the first lenticular grating is the first supporting element and/or the second lenticular grating is the second supporting element.

10. The display device (1, 10) according to claim 1, wherein a second pattern is sandwiched between the second lenticular grating (12, 112) and the second supporting element.

11. A watch comprising the display device (1, 10) according to claim 1.
